(19) United States
(12) Patent Application Publication
(10) Pub. No.: US 2025/0378094 A1
(43) Pub. Date: Dec. 11, 2025

(54) SYSTEMS, APPARATUSES, METHODS, AND NON-TRANSITORY COMPUTER-READABLE STORAGE MEDIA FOR ADAPTIVE INFORMATION RETRIEVAL FOR QUESTION-ANSWERING

(71) Applicant: HUAWEI TECHNOLOGIES CO., LTD., Shenzhen (CN)

(72) Inventors: Mehdi Rezagholizadeh, Vaughan (CA); Mohammad Dehghan, Whitby (CA); Sunyam Bagga, Kanata (CA); Prasanna Parthasarathi, Kanata (CA); Boxing CHEN, Ottawa (CA); David Alfonso Hermelo, Kanata (CA); Xiaoguang Li, Kanata (CA)

(73) Assignee: HUAWEI TECHNOLOGIES CO., LTD., Shenzhen (CN)

(21) Appl. No.: 18/966,898

(22) Filed: Dec. 3, 2024

Related U.S. Application Data
(60) Provisional application No. 63/656,289, filed on Jun. 5, 2024.

(51) Int. Cl. G06F 16/3329; G06F 16/338; G06F 40/10; G06F 40/284; G06F 40/30

(52) U.S. Cl. CPC G06F 16/33295; G06F 16/338; G06F 40/10; G06F 40/284; G06F 40/30

(57) ABSTRACT

Methods and systems for retrieving relevant information in response to an input question. The method includes obtaining text content related to the input question and partitioning the content into one or more paragraphs based on predefined rules. The method further involves extracting one or more evidence spans that are relevant to the input question by inputting the text content and the question into a trained language model. A semantic search is then performed on both the paragraphs and the extracted evidence spans, ranking the candidate passages based on their relevance to the input question. Each candidate passage may comprise either a paragraph or an evidence span that addresses the question. The disclosed methods and systems improve the quality and relevance of retrieved information by combining heuristic-based content partitioning with machine learning-based evidence extraction.

### CROSS-REFERENCE TO RELATED APPLICATION

The present applications claims priority to U.S. provisional patent application No. 63/656,289, filed on Jun. 5, 2024, and entitled, “SYSTEMS, APPARATUSES, METHODS, AND NON-TRANSITORY COMPUTER-READABLE STORAGE MEDIA FOR ADAPTIVE INFORMATION RETRIEVAL FOR QUESTION-ANSWERING,” the entirety of which is hereby incorporated by reference herein.

### TECHNICAL FIELD

The present disclosure relates generally to systems, apparatuses, methods, and computer-readable storage media for large language model, and in particular to systems, apparatuses, methods, and computer-readable storage media for adaptive information retrieval for question-answering.

### BACKGROUND

Large language models (LLMs) are neural network models that learn the semantics and syntax of language by encoding words or subwords into vector representations. These models are trained on extensive datasets and are widely used in various artificial intelligence (AI) applications, including text generation, sentiment analysis, and generic question-answering (QA) systems. LLMs enable these systems to understand and generate responses to a broad range of queries, making them integral to applications like virtual assistants and chatbots.

However, existing LLM-based QA systems face some challenges. One major drawback is the high computational cost associated with LLMs, which require substantial resources for inference. This often results in slow response times, affecting user experience, particularly in real-time applications. Additionally, LLMs are prone to generating incomplete or inaccurate responses, especially when tasked with answering complex or domain-specific queries, limiting their reliability in providing precise answers.

Moreover, LLMs in QA systems may struggle with retrieving and processing relevant information efficiently. While they are capable of generating responses based on internalized knowledge, LLMs may not always retrieve the most contextually appropriate information from external sources, leading to answers that may not fully address the user's query.

### SUMMARY

According to one aspect of this disclosure, there is provided a computerized method for retrieving relevant information in response to an input question comprising obtaining text content in relation to the input question, partitioning the obtained text content into one or more paragraphs based on a predefined rule, extracting one or more evidence spans from the obtained text content relevant to the input question using a trained language model and performing semantic search on the one or more paragraphs and the extracted one or more evidence spans based on the input question to rank candidate passages, wherein each of the candidate passages comprises one of the one or more paragraphs or one of the one or more extracted evidence spans that is relevant to the input question.

In some embodiments, obtaining the text content comprises conducting a search based on the input question using an Internet-based or Intranet-based search engine.

In some embodiments, the predefined rule is a heuristic rule, and wherein the partitioning comprises utilizing a structural element in the text content to define boundaries of the one or more paragraphs, in response to one of the one or more paragraphs containing fewer than a predefined minimum number of tokens, discarding the paragraph and in response to one of the one or more paragraphs containing more than a predefined maximum number of tokens, dividing the paragraph into shorter paragraphs without breaking sentence structures.

In some embodiments, the structural element comprises one or more of: a newline character, a paragraph tag, a sentence boundary, a section header, or a list item.

In some embodiments, performing the semantic search comprises inputting the one or more paragraphs, the extracted one or more evidence spans, and the input question to a retriever configured to rank the candidate passages based on semantic similarity between each of the candidate passages and the input question.

In some embodiments, fine-tuning the trained language model using a training dataset comprises a plurality of question-context-evidence triples, each of the plurality of question-context-evidence triples containing a training question, context text comprising training text content relevant to the training question and one or more training evidence spans corresponding to one or more portions of the training text content, wherein the one or more training evidence spans are annotated by a human editor based on their relevance to the training question.

In some embodiments, the candidate passages are ranked based on one or more criteria selected from the group consisting of relevance in relation to the input question, coverage, and self-containment, wherein the self-containment represents one of the candidate passages containing complete information to answer the input question.

In some embodiments, the method further comprises caching the obtained text content associated with the input question for subsequent queries related to the input question. In some embodiments, the trained language model is an encoder-only transformer model.

According to another aspect of this disclosure, there is provided a method for training a language model, wherein the language model extracts one or more evidence spans from text content and an input question. The method comprises providing a training dataset comprising a plurality of question-context-evidence triples, each of the plurality of question-context-evidence triples containing a training question, training text content relevant to the training question and one or more training evidence spans corresponding to one or more portions of the training text content, inputting the training dataset to the language model and training the language model to learn patterns between the training questions and the annotated training evidence spans within the training text content. In some embodiments, the one or more training evidence spans have previously been annotated by a human editor based on their relevance to the training question.

In some embodiments, the training text content comprises a full text of a webpage relevant to the training question. In some embodiments, the language model is an encoder-only transformer model.

According to another aspect of this disclosure, there is provided a system for retrieving relevant information in response to an input question, the system comprising a processor and a memory communicatively coupled to the processor and storing instructions. When the instructions are executed by the processor, the system will obtain text content in relation to the input question; partition the obtained text content into one or more paragraphs based on a predefined rule; extract one or more evidence spans from the obtained text content relevant to the input question using a trained language model; and perform semantic search on the one or more paragraphs and the extracted one or more evidence spans based on the input question to rank candidate passages, wherein each of the candidate passages comprises one of the one or more paragraphs or one of the one or more extracted evidence spans that is relevant to the input question.

In some embodiments, the memory stores the instructions that, when executed by the processor, cause the system to conduct a search based on the input question using an Internet-based or Intranet-based search engine to obtain the text content.

In some embodiments, the memory stores the instructions that, when executed by the processor, cause the system to partition the text content according to a heuristic rule, wherein the partitioning comprises: utilizing a structural element in the text content to define boundaries of the one or more paragraphs; in response to one of the one or more paragraphs containing fewer than a predefined minimum number of tokens, discarding the paragraph; and in response to one of the one or more paragraphs containing more than a predefined maximum number of tokens, dividing the paragraph into shorter paragraphs without breaking sentence structures.

In some embodiments, the memory stores the instructions that, when executed by the processor, cause the system to perform semantic search by inputting the one or more paragraphs, the extracted one or more evidence spans, and the input question into a retriever configured to rank the candidate passages based on semantic similarity between each of the candidate passages and the input question.

In some embodiments, the memory stores the instructions that, when executed by the processor, cause the system to rank the candidate passages based on one or more criteria selected from the group consisting of relevance in relation to the input question, coverage, and self-containment, wherein the self-containment represents one of the candidate passages containing complete information to answer the input question.

In some embodiments, the memory stores the instructions that, when executed by the processor, cause the system to cache the obtained text content associated with the input question for subsequent queries related to the input question. In some embodiments, the trained language model is an encoder-only transformer model.

In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a non-transitory computer-readable medium storing instruction the instructions causing a processor in a device to implement any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configure to perform any of the methods disclosed herein.

According to one aspect of this disclosure, there is provided a module comprising: one or more circuits for performing any of the methods disclosed herein.

According to one aspect of this disclosure, there is provided an apparatus comprising: one or more processors functionally connected to one or more memories for performing any of the methods disclosed herein.

According to one aspect of this disclosure, there is provided an apparatus configured to perform any of the methods disclosed herein. In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform any of the methods disclosed herein.

According to one aspect of this disclosure, there is provided one or more computer-readable storage media storing a computer program, wherein, when the computer program is executed by an apparatus, the apparatus is enabled to implement any of the methods disclosed herein.

According to one aspect of this disclosure, there is provided a computer program product including one or more instructions, wherein, when the instructions are executed by an apparatus, the apparatus is enabled to implement any of the methods disclosed herein.

According to one aspect of this disclosure, there is provided a computer program, wherein, when the computer program is executed by a computer, an apparatus is enabled to implement any of the methods disclosed herein.

The embodiments described herein provide several advantages in retrieving relevant information in response to input questions. By employing a combination of heuristic-based partitioning and a trained language model for evidence extraction, the system improves the quality and precision of retrieved passages. In contrast to conventional approaches that may retrieve entire paragraphs regardless of their relevance, the disclosed method leverages an intelligent evidence extractor that isolates relevant portions of text, thereby reducing noise and improving the overall quality of the candidate passages.

Furthermore, the embodiments described herein enhance the self-containment of the extracted information. Rather than breaking down passages based on arbitrary rules, the evidence extractor ensures that the retrieved evidence spans are more likely to be complete and self-contained. This feature is particularly advantageous in ensuring that each segment of information can independently answer the input question without requiring additional context, thus improving the reliability and clarity of the retrieved data.

In addition, the embodiments described herein offer improved coverage by handling a wide variety of queries from diverse external knowledge sources. By performing semantic search on both partitioned paragraphs and extracted evidence spans, the system is well-suited for open-domain question-answering, particularly in environments such as generative search engines. This comprehensive approach enables the system to retrieve and rank relevant information effectively, making it adaptable for various applications requiring accurate and efficient information retrieval.

### BRIEF DESCRIPTION OF THE DRAWINGS

For a more complete understanding of the disclosure, reference is made to the following description and accompanying drawings, in which:

FIG. 1 is a schematic diagram of a computer network system, according to some embodiments of this disclosure;

FIG. 2 is a schematic diagram showing a simplified hardware structure of a computing device of the computer network system shown in FIG. 1;

FIG. 3 is a schematic diagram showing a simplified software architecture of a computing device of the computer network system shown in FIG. 1;

FIG. 4 is a schematic diagram showing an artificial intelligence (AI) engine, according to some embodiments of this disclosure;

FIG. 5 is a schematic diagram showing the pipeline of a citation-based question-answering system;

FIG. 6 is a schematic diagram showing a prior art procedure for document processing using a document splitter;

FIG. 7 is a schematic diagram showing an example of character splitting;

FIG. 8 is a schematic diagram showing an example of a recursive text splitter;

FIG. 9 is a multi-stage retrieval process for responding to a user query, according to some embodiments of this disclosure;

FIG. 10 is a bar chart comparing the presence of candidate passages identified by the evidence extractor and paragraph splitter at various top-ranked positions, illustrating the percentage of queries where a passage from each approach ranked in these positions, according to some embodiments of this disclosure.

FIG. 11 is a box plot comparing the ranking distribution of passages selected by the evidence extractor and the paragraph splitter, showing the median, range, and distribution of ranks for each method, according to some embodiments of this disclosure.

FIG. 12 is an example illustrating the flow of the multi-stage retrieval process shown in FIG. 9;

FIG. 13 is a comparison between WebGLM and the adaptive information retrieval method according to some embodiments of this disclosure in terms of human evaluation;

FIG. 14 is a distribution of quotes retrieved by the answer composer from different data sources;

FIG. 15 is a graphical representation comparing the accuracy and relative speed of various models;

FIG. 16 shows the extracted quotes when the adaptive information retrieval method is used to answer the question “Messi or Maradona, who is better?” according to some embodiments of this disclosure;

FIG. 17 shows the final LLM-generated answer based on the extracted quotes retrieved during the semantic search, demonstrating the improved quality of the generated response;

FIG. 18 shows the extracted quotes when the adaptive information retrieval method is used to answer the query “Write a piece of poem about mother,” according to some embodiments of this disclosure; and

FIG. 19 shows two exemplary poems about mothers, illustrating the kind of content that the system can retrieve and cite as evidence passages in response to user queries.

### DETAILED DESCRIPTION

Embodiments disclosed herein relate to systems and apparatuses using large language models (LLMs). The systems and apparatuses disclosed herein may comprise suitable modules and/or circuitries for executing various procedures.

As those skilled in the art understand, a “module” is a term of explanation referring to a hardware structure such as a circuitry implemented using technologies such as electrical and/or optical technologies (and with more specific examples of semiconductors) for performing defined operations or processing. A “module” may alternatively refer to the combination of a hardware structure and a software structure, wherein the hardware structure may be implemented using technologies such as electrical and/or optical technologies (and with more specific examples of semiconductors) in a general manner for performing defined operations or processing according to the software structure in the form of a set of instructions stored in one or more non-transitory, computer-readable storage devices or media.

As will be described in more detail below, a module may be a part of a device, an apparatus, a system, and/or the like, wherein the module may be coupled to or integrated with other parts of the device, apparatus, or system such that the combination thereof forms the device, apparatus, or system. Alternatively, the module may be implemented as a standalone device or apparatus.

The module usually executes a procedure for performing a method. Herein, a procedure has a general meaning equivalent to that of a method. More specifically, a procedure is a defined method implemented using hardware components for processing data. A procedure may comprise or use one or more functions for processing data as designed. Herein, a function is a defined sub-procedure or sub-method for computing, calculating, or otherwise processing input data in a defined manner and generating or otherwise producing output data.

As those skilled in the art will appreciate, a procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module may read the computer-executable code from the storage devices and execute the computer-executable code to perform the procedure.

Alternatively, a procedure may be implemented as one or more hardware structures having necessary electrical and/or optical components, circuits, logic gates, integrated circuit (IC) chips, and/or the like.

### Context

### A. System Structure

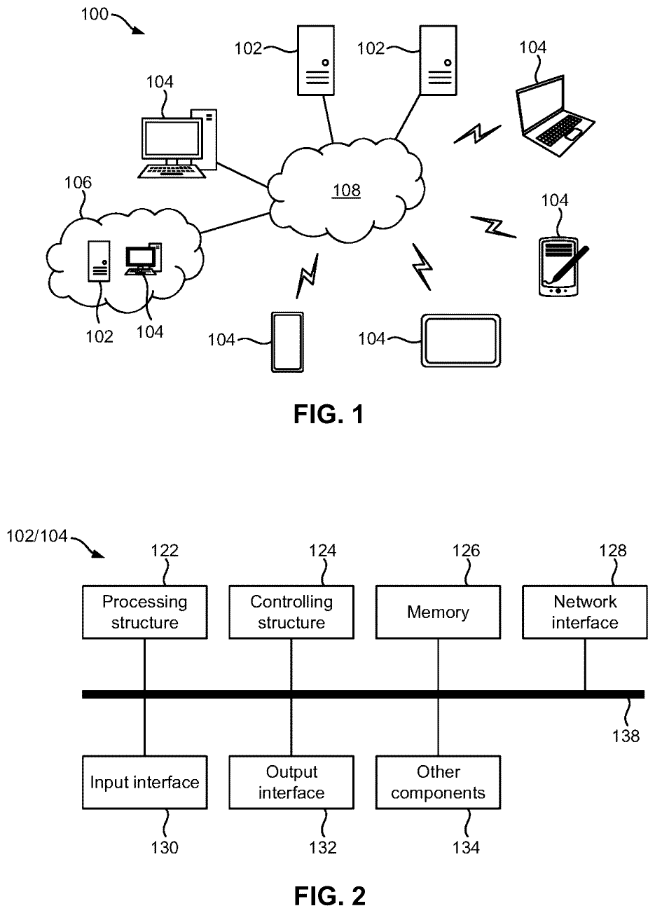

Turning now to FIG. 1, a computer network system is shown and is generally identified using reference numeral 100. As shown, the computer network system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

Generally, the computing devices 102 and 104 comprise similar hardware structures such as hardware structure shown in FIG. 2. As shown, the computing device 102/104 comprises a processing structure 122, a controlling structure 124, one or more non-transitory computer-readable memory or storage devices 126, a network interface 128, an input interface 130, and an output interface 132, functionally interconnected by a system bus 138. The computing device 102/104 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, NVIDIA processor, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), μ-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case maybe. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processing thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, fifth-generation New Radio (5G NR) and/or other 5G networks, fifth-generation (6G) networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

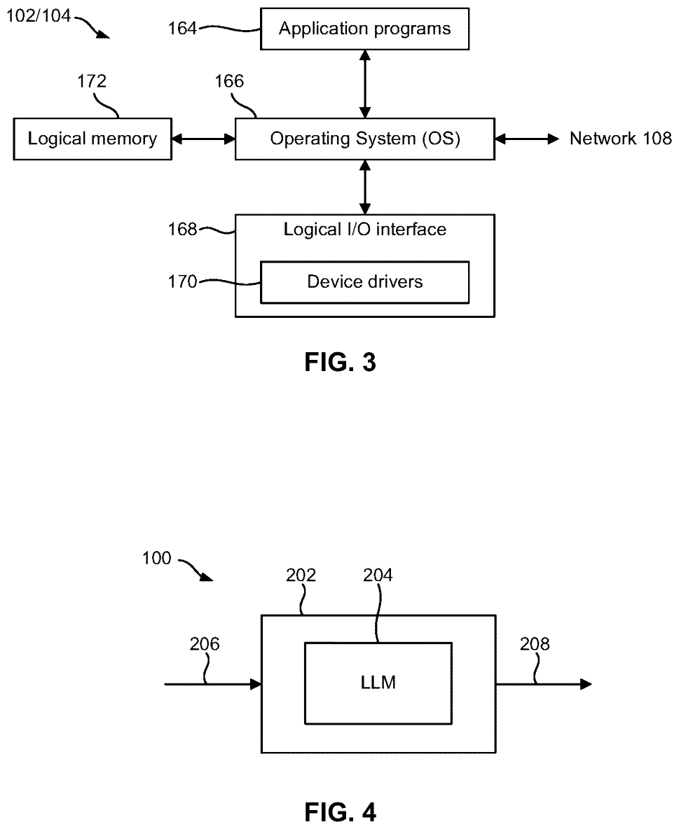

FIG. 3 shows a simplified software architecture of the computing device 102 or 104. On the software side, the computing device 102 or 104 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 104 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the computer network system 100 may have the potential to perform various tasks, it cannot perform any tasks and is of no use without meaningful firmware and/or software. As will be described in more detail later, the computer network system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

### B. Large Language Model

In some embodiments, the computer network system 100 executes an artificial intelligence (AI) engine (for example, in the form of one or more software programs) for natural language processing. As shown in FIG. 4, the AI engine 202 comprises a LLM 204 for processing natural language input 206 (for example, in the form of text, voice, and/or the like), recognizing and interpreting the natural language input 206 for generating the output 208 in suitable forms.

As those skilled in the art will appreciate, LLMs are neural network models that are designed to learn the semantics and syntax of language by encoding words or subwords into vector representations. LLMs are often trained for text generation, where, given an input sentence (or prompt), the model predicts the next most probable word or subword in sequence. This process is commonly referred to as auto-regressive language modeling. Due to this training methodology, LLMs can be utilized in generic question-answering (QA) systems. For example, when provided with a question and an instruction (such as, “Answer the following question: Who is the author of the Harry Potter series?”), the model may sequentially output words based on the input prompt, potentially producing an answer like “J. K. Rowling.”

Some of the more advanced LLMs may contain billions of trainable parameters and are typically based on the decoder-only Transformer architecture. The training datasets used for these models can include vast amounts of text, such as trillions of words sourced from various domains, including the web. LLMs may be adapted for specific tasks through techniques like fine-tuning, where internal model parameters are updated, or through prompt-engineering, where only the input prompts are adjusted without requiring further changes to the model parameters.

Herein, knowledge graphs (KGs) are general knowledge bases used to represent real-world data in a structured manner. Graphs are comprised of a set of nodes V and edges E. Node represent key objects (for example, people) and can have many attributes (for example, age, name, and/or the like). An edge represents a relationship between two nodes (for example, friend). KG nodes are referred to as entities. KG edges are sometimes referred to as triples as they are comprised of an object node, relation, and subject node. A pair of nodes can have multiple unique edges. KGs are often used to model complex real-world data (for example, finance) for large-scale systems (for example, search engines, recommendation systems). Examples of KGs include WikiData (https://www.wikidata.org/) and ConcpetNet (https://conceptnet.io/). Triples can be retrieved from KGs through simple entity search (that is, finding all triples involving a particular object) or more advanced methods such as SPARQL (https://www.w3.org/TR/sparql11-query/).

LLMs may typically respond to prompts using the knowledge stored within their internal parameters. Retrieval-augmented generation (RAG) is a technique that can be used to improve the accuracy and reliability of LLMs by supplementing the prompt with additional relevant information. In this technique, an information retrieval component may use the prompt to retrieve data from an external knowledge source, such as a knowledge graph (KG). The user prompt, along with the retrieved information, can then be provided to the LLM. By combining the external information with its internal knowledge, the LLM may generate more accurate responses while reducing instances of hallucination. As used herein, “hallucination” refers to cases where the LLM generates text that appears plausible but is factually incorrect, often involving fabricated details or facts.

The mechanics of information retrieval may depend on the type of knowledge source used. For example, retrieving information from a knowledge graph (KG) can involve processes such as entity linking and identifying the most relevant neighborhood within the graph. The retrieved triples, which represent relationships between entities (e.g., [John, spouse, Betty]), can then be incorporated into the input prompt in textual form. In this context, entity linking refers to identifying and connecting mentions of entities within a text to their corresponding entries in the knowledge graph, effectively mapping textual data to a structured knowledge base. Additionally, the neighborhood of a node in a knowledge graph typically refers to its immediate connections, such as a user's followers in a social network.

LLMs have shown considerable potential for use in QA tasks. However, relying solely on the internal knowledge stored within LLMs, whether gained from pre-training or fine-tuning, may lead to several issues, such as hallucinations, outdated information, or gaps in knowledge. Specifically, LLMs can face limitations in knowledge-intensive tasks, particularly those requiring domain-specific expertise or complex reasoning that extends beyond the training data. Additionally, LLMs may struggle when up-to-date information is needed and are prone to generating factually incorrect responses, known as hallucinations.

To address these challenges, RAG can be employed to ground LLM responses by integrating external knowledge sources, such as the web or a knowledge graph. This approach may help reduce the incidence of hallucinations by enriching the LLM's internal knowledge with external data. However, a key challenge remains in distinguishing which parts of a response are derived from external knowledge sources and which are generated from the LLM's internal parameters, a concept known as knowledge grounding.

### Existing Information Retrival

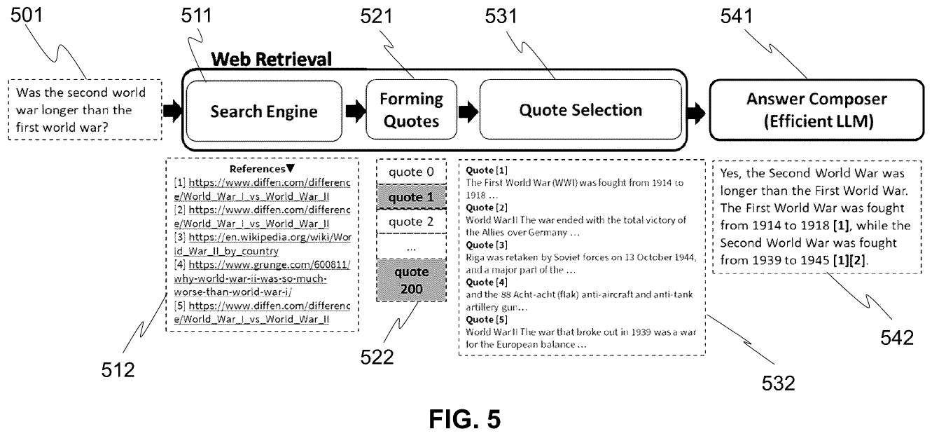

FIG. 5 illustrates a citation-based QA system that utilizes a web-retrieval module to generate well-grounded answers to input queries by incorporating citations from relevant external knowledge sources. The figure demonstrates how the system processes an input question at 501, such as “Was the second world war longer than the first world war?” and retrieves relevant information to provide an accurate and grounded response.

The system begins with a search engine component 511, which retrieves a list of relevant web pages containing potential answers to the input question. The retrieved sources are presented as references 512, such as webpages discussing the timeline and details of World War I and World War II. After retrieving the sources, the system proceeds to form quotes at 521, extracting relevant pieces of information 522 (quotes) from the various retrieved pages. For instance, as shown at 532 in FIG. 5, Quote [1] indicates that the First World War was fought from 1914 to 1918, while Quote [2] states that the Second World War ended with the total victory of the Allies over Germany. These quotes are extracted from the retrieved webpages and are listed for further processing.

Next, a quote selection mechanism 531 filters and ranks the most relevant quotes based on their relation to the input query. In this example, the system selects the quotes that directly answer the question about the two world wars. Once the relevant quotes are identified, they are passed to the answer composer 541, which uses an efficient LLM to construct a final answer 542. As shown in the example, the system responds that the Second World War was indeed longer than the First World War, citing the relevant timeframes and including proper citations from the retrieved sources (e.g., [1] and [2]).

The citation-based QA system depicted in FIG. 5 utilizes knowledge grounding, which is achieved by linking the final answer to reliable, external sources. This process helps ensure that the information provided is accurate and trustworthy. By including proper citations, the system makes it clear where the information originated, improving both transparency and reliability.

Retrievers, such as the one shown in FIG. 5, may be constrained by predefined heuristics, such as extracting entire paragraphs from limited sources like Wikipedia™. While these heuristics can improve efficiency, they are not always suitable for a diverse set of queries, especially in open-domain QA systems where the questions may vary widely in complexity and subject matter. To provide comprehensive answers, retrievers need to extract self-contained, diverse evidence from a broad array of knowledge sources across the web, rather than relying solely on well-structured documents. This allows the system to adapt to the wide variety of questions users might ask, ensuring that the evidence used is both relevant and comprehensive.

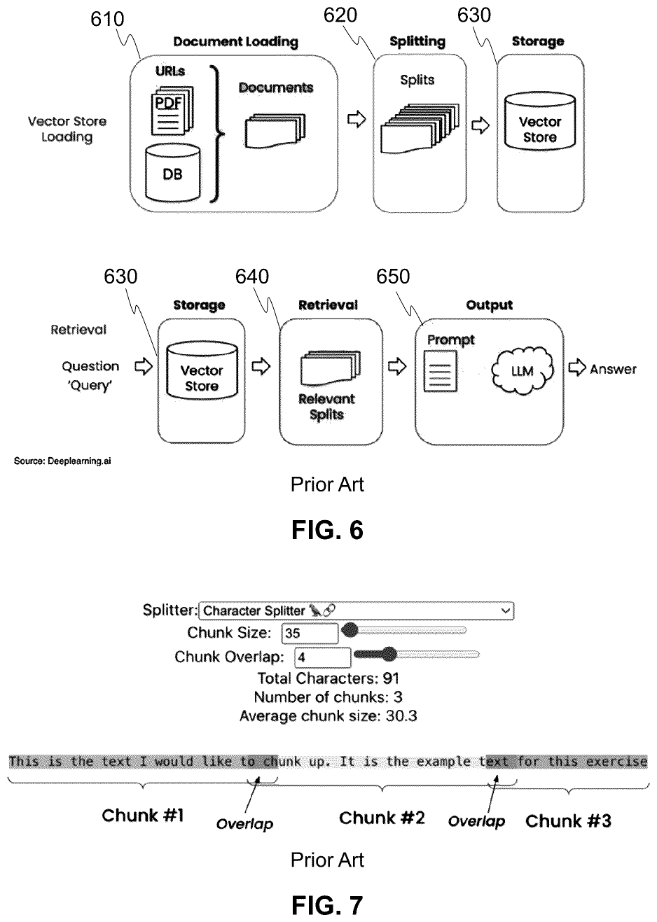

FIG. 6 illustrates a prior art procedure for document processing using a document splitter (obtained from deeplearning.ai with modification). This procedure begins with the document loading phase 610, where Uniform Resource Locators (URLs) or other document sources (such as PDFs or databases) are processed, and the content is loaded. The documents are then fed into a splitting module 620, which breaks them down into smaller segments known as splits. These splits are stored in a vector store 630, a type of storage designed for efficient retrieval of relevant information in vector format. When a user input or query is provided, the system retrieves relevant splits from the vector store at 640 and then processes the information using a language model to generate an output or answer at 650. This process forms the basis for information retrieval systems, such as those found in question-answering applications that rely on LLMs.

FIG. 7 further details an existing splitting technique, character splitting, where the text is divided into fixed-length chunks based on a specific number of characters. In this example, the text is split into chunks of 35 characters each, with an overlap of 4 characters between consecutive chunks. This overlap ensures that important contextual information that might span across chunk boundaries is retained, helping the LLM provide better responses. For example, Chunk #1 and Chunk #2 share 4 characters of overlap (“o ch”) to maintain continuity between them, improving how the chunks are handled when processed later by the language model.

Although character splitting ensures that text is divided into manageable segments, it typically employs a global constant chunk size, meaning it does not adapt based on the content or meaning of the text. As such, a document may be split arbitrarily without considering sentence boundaries or important context, which can affect the quality of the retrieval and the answer generation by the LLM.

In the context of LLMs, a “paragraph” refers to a coherent block of text, typically made up of multiple sentences that together express a unified idea or topic. Paragraphs are often separated by newline characters or HTML paragraph tags, serving as natural structural divisions within a document. However, when processing large amounts of text, LLMs may break paragraphs down into smaller units, known as chunks, to make them more manageable for analysis.

A “chunk” is a segment of text produced by dividing paragraphs or documents into smaller parts. Chunks can be generated using different methods, such as character-based or sentence-based splitting. As shown in FIG. 7, chunks are created based on a fixed number of characters, with overlapping segments to ensure that important contextual information is preserved across chunk boundaries. This process allows the LLM to handle large texts more efficiently while still retaining necessary context between chunks.

Within these chunks, a “token” refers to a more granular unit of text. A token can be a word, subword, or even a character, depending on how the language model processes the text. In many LLM architectures, tokenization is used to break down the text into manageable units that the model can interpret. For example, in tokenization, common words like “dog” may be treated as a single token, while longer or unfamiliar words may be split into subword tokens, such as “un-”, “break-”, and “-able”. Tokenization helps the model handle variations in language and efficiently process large datasets.

Moving to smaller units, a “word” is a fundamental building block of language, representing a meaningful standalone unit, such as a single vocabulary item. In natural language processing, words are typically used as the primary unit for analysis. However, to handle rare or unknown words, LLMs may break words into smaller components called morphemes. “Morphemes” are the smallest units of meaning in a language and include prefixes, suffixes, and root words. For example, in the word “displacement”, “dis-”, “place”, and “-ment” are morphemes.

In some cases, LLMs break words or morphemes further into subword units. These subword units are particularly useful for dealing with out-of-vocabulary words by dividing them into frequently occurring smaller components. For example, a word like “reusability” may be split into subword units such as “reuse” and “ability”. This allows the model to generalize and recognize patterns across different words and word forms. At the smallest level, a “character” represents an individual symbol or letter, such as “a”, “1”, or “-” within a text.

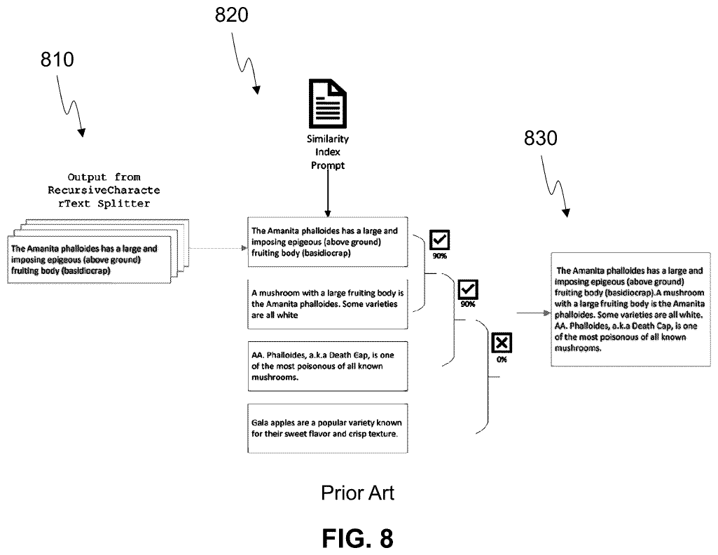

FIG. 8 illustrates the operation of an existing recursive text splitter in a system designed for processing and comparing text. The recursive text splitter breaks down an input text into progressively smaller segments based on a list of pre-specified separators. These separators may include characters like double new lines (“\n\n”), single new lines (“\n”), spaces (“ ”), or individual characters. The recursive splitting ensures that the text is divided into chunks at meaningful points, preserving context while making the text manageable for subsequent processing steps.

In FIG. 8, the input text is passed through the recursive text splitter, which divides it into multiple overlapping segments at 810. These segments are used for further analysis, such as similarity comparison or relevance ranking.

Following the splitting process, the text undergoes a similarity index check at 820, where each segment is compared with the input prompt or query to determine its similarity. In this example, the similarity index is used to match segments of the input text with other related pieces of information. The output shows multiple variations of the text, each compared to the original input for similarity. Segments that match the original text closely are given a high similarity score (e.g., 90%, as shown in FIG. 8), while unrelated or less similar segments, such as the reference to Gala apples at the bottom, are assigned a low or zero similarity score.

Finally, the system compiles the most similar segments into a final, aggregated output at 830. In this example, the system generates an output that combines the top matching segments into a coherent answer or passage. For example, the output may combine the top two segments to create a more complete description of the Amanita phalloides, including details about its fruiting body and its poisonous nature. By recursively splitting and recombining text, the system ensures that the generated output is accurate and contextually relevant.

In addition to recursive text splitting, there are several other methods for dividing text into manageable segments for processing by LLMs and related systems. One of these methods is semantic chunking, which is a method that first splits a document into sentences, then merges consecutive sentences if they are semantically similar. This approach ensures that text chunks maintain contextual integrity, allowing language models to process and interpret the information more effectively. By preserving meaning across sentences, semantic chunking enhances tasks like summarization and question-answering.

Another approach, referred to as agent splitting, involves the use of sophisticated language models (such as third-party LLMs) or specialized agents to divide documents. Instead of relying on predefined rules, the model analyzes the content to determine the optimal splitting points. This method offers high precision and is particularly useful for complex or unstructured content. However, it can be computationally expensive and is typically employed in cases where accuracy and content preservation are crucial, such as legal or technical document processing.

Table 1 illustrates the trade-offs between different approaches to information retrieval and text segmentation. Traditional methods such as Character Splitting and Recursive Splitting, though fast, are often limited in their ability to adapt to the semantic structure of text, leading to suboptimal results in many cases. These methods operate with high inference speed but provide limited contextual understanding and are prone to retrieving incomplete or noisy passages. On the other hand, more advanced techniques like Semantic Chunking and Agent Splitting offer improved semantic understanding, but they come with the downside of lower inference speed and significantly higher computational costs, making them less practical for real-time applications.

TABLE 1
Comparison of information retrival methods for QA

| | Adaptive | | Inference | |
|---|---|---|---|---|
| Method | Size | Semantic | Speed | Cost |
| Character Splitting | x | x | High | $ |
| Recursive Splitting | x | x | High | $ |
| Semantic Chunking | ✓ | ✓ | Low | $$$ |
| Agent Splitting | ✓ | ✓ | moderate | $$$$ |
| Enhanced adaptive | ✓ | ✓ | moderate | $$ |
| information retrieval | | | | |

In contrast, the approach described herein, referred to as Enhanced Adaptive Information Retrieval, strikes an optimal balance between semantic performance, speed, and cost. This approach adapts the chunk size based on the content, ensures semantic coherence, and operates at moderate cost and inference speed. By leveraging a combination of heuristic-based splitting and advanced model-based extraction, it outperforms simpler methods in terms of quality and relevance, without incurring the high computational expenses associated with agent-based approaches, benefiting applications requiring efficient yet accurate retrieval in open-domain question-answering systems and other AI-driven processes.

### Enhanced Adaptive Information Retrieval

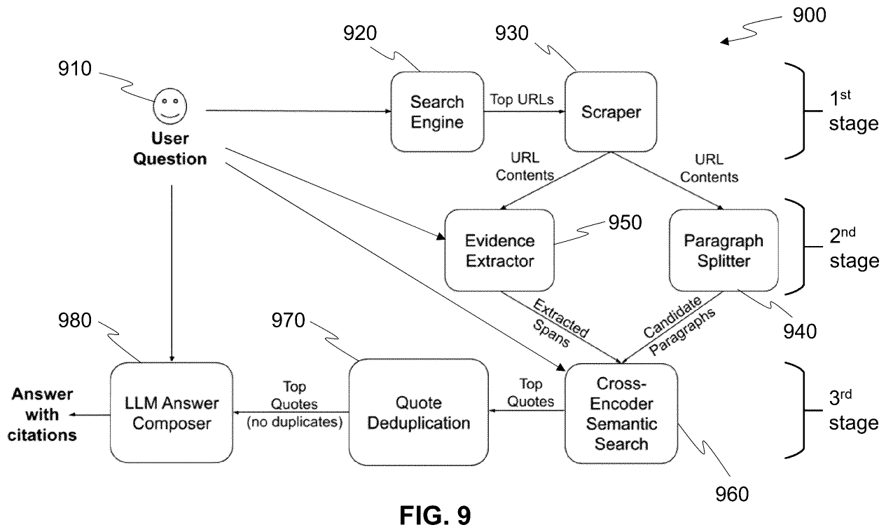

FIG. 9 illustrates a multi-stage retrieval process for responding to a user query by retrieving relevant information from web sources according to one embodiment described herein. Specifically, the first stage involves obtaining text content in relation to the input question; the second stage involves a hybrid extraction of passages via both a heuristic-based paragraph splitter and a pre-trained semantic evidence extractor; and the third stage involves a semantic search that ranks the passages in terms of relevance for LLM formulations. The system 900 begins by receiving an input question or user question 910, which is processed by several components to retrieve, extract, and rank evidence that is relevant to answering the question. For example, the user question may be in natural language, such as “Was the second world war longer than the first world war?” described in relation to FIG. 5.

Upon receiving the user question, the system 900 may obtain text content by conducting a search using a web search engine 920, which returns URLs containing potentially relevant information. A scraper component 930 may extract the content from these URLs. In some examples, the scraper component 930 may extract the contents of each webpage identified by the search engine. For efficiency, tools it may use like BeautifulSoup (https://www.crummy.com/software/BeautifulSoup/) to parse the HTML structure and retrieve the text content, including the visible body text, metadata, and other relevant elements.

To handle the time-consuming task of scraping and parsing large volumes of webpages, the system 900 may utilize multi-threading, which enables the scraper 930 to process multiple URLs in parallel. This parallel processing significantly reduces the time required to scrape large amounts of data from diverse web sources. Once the text content is scraped, it may be cached in a database to improve efficiency for subsequent queries, allowing the system to reuse previously fetched content rather than repeatedly accessing the same URLs.

The web search engine 920 may be a third-party search engine, such as Google™, Bing™, or any other widely used platform that provides access to vast amounts of publicly available information on the Internet. These search engines typically index a broad range of content, including web pages, articles, and other documents, allowing the system 900 to retrieve a diverse set of URLs based on the user's input question. In some embodiments, the system 900 may integrate with such third-party search engines via Application Programming Interfaces (APIs), enabling it to programmatically send user questions and receive relevant search results.

The retrieved URLs may point to different types of content, including structured data, such as Wikipedia™ entries or academic papers, and unstructured data, like blog posts or news articles. The use of a third-party search engine ensures that the system is not limited to a specific, predefined knowledge base, making it well-suited for handling open-domain queries. Additionally, the system may utilize custom search parameters or filters offered by these search engines to refine its queries, improving the relevance and quality of the URLs returned for further processing. Additionally, caching the search engine results and/or the scraped URL contents in a database may further improve processing speed for recurring or related queries.

It should be understood that the content may be extracted not only from the Internet but also from other sources, such as an Intranet. For example, in the case of an internal organizational network, the scraper may retrieve content from a private database or a knowledge repository, such as a university's digital library or an enterprise-level content management system where large volumes of data are stored. The scraper may be configured to handle various formats of web pages and other documents, extracting the relevant portions of text that will be further processed by downstream components. In some embodiments, the scraping process may involve parsing HTML structures, such as <p> tags or headings, to extract structured text, ensuring that important content is captured efficiently from various sources. Additionally, the system may employ multithreading techniques to speed up the process by scraping multiple pages in parallel, improving the system's overall efficiency when dealing with large datasets or multiple URLs.

The scraped content is then processed by two parallel pathways: a paragraph splitter 940 and an evidence extractor 950. The paragraph splitter 940 may apply a heuristic-based approach to divide the scraped content into one or more paragraphs. A heuristic-based approach refers to a method that uses predefined rules or shortcuts to achieve a quick and efficient solution. In this context, the paragraph splitter 940 may rely on structural elements within the text, such as newline characters, paragraph tags (<p>), or sentence boundaries, to define the boundaries of paragraphs or chunks of text.

For example, paragraphs that contain fewer than a predefined minimum number of tokens, such as 10 tokens, may be discarded, considering them insufficiently informative for further processing. This step ensures that the system does not waste resources on processing very short, likely irrelevant pieces of text. Conversely, if a paragraph contains more than a predefined maximum number of tokens, such as 80 tokens, the system may divide that paragraph into shorter paragraphs, ensuring that sentence structures are not broken during this process.

In addition, the system may maintain logical coherence by ensuring that sentences are not split in a way that would lose their meaning or context. This process ensures that the resulting paragraphs are of manageable length while still preserving the meaning and structure of the original content. The use of such heuristic rules allows the system to handle large volumes of text efficiently by organizing it into coherent, contextually meaningful passages without relying on more computationally expensive methods. In some embodiments, the structural elements used to define paragraph boundaries may include one or more of the following: newline characters, paragraph tags, sentence boundaries, section headers, list items, or any other recognizable structural feature indicative of a meaningful division within the text, offering flexibility in how the text is split depending on the type of document or its formatting.

In contrast, the evidence extractor 950 uses a trained encoder-only transformer model to extract evidence spans directly from the text, without relying on predefined rules. The encoder-only transformer is a neural network model based on the transformer architecture, but it focuses solely on the encoding process rather than incorporating both encoding and decoding functions, as seen in models like BERT (Bidirectional Encoder Representations from Transformers). This model processes the input text in parallel, capturing complex relationships between words and phrases through attention mechanisms, which allow it to focus on different parts of the text depending on the context of the user question. Unlike simpler models that rely on predefined heuristics, the encoder-only transformer dynamically determines which spans of text are most relevant by leveraging patterns it has learned from its training dataset.

The transformer model is trained on a dataset that includes question-context-evidence triples-combinations of a training question, context text (e.g., a passage or document), and one or more training evidence spans (a relevant portion of the context). By analyzing these patterns, the model learns to identify specific portions of the text that are more likely to contain answers to the user question. The use of an encoder-only transformer allows for a more flexible and contextually aware approach to extracting relevant information, which improves the precision of the retrieval process.

While the encoder-only transformer is suitable for evidence extraction due to its ability to capture context and relationships within the text, alternative models may also be employed in some embodiments. For example, a full transformer model that includes both an encoder and decoder, such as GPT (Generative Pre-trained Transformer), may be used, particularly if generating responses is prioritized alongside retrieval. Additionally, other deep learning architectures, such as recurrent neural networks (RNNs) or convolutional neural networks (CNNs), may be adapted for this task.

In the context of LLMs, the term evidence span refers to a segment of text that is highly relevant and self-contained, meaning it provides sufficient information to answer the input question. Unlike paragraphs, which are divided based on structural cues, evidence spans are selected through semantic analysis, making them more likely to address the user's query directly. These spans are not bound by the same heuristic rules used by the paragraph splitter, allowing for a more flexible and context-aware extraction of information.

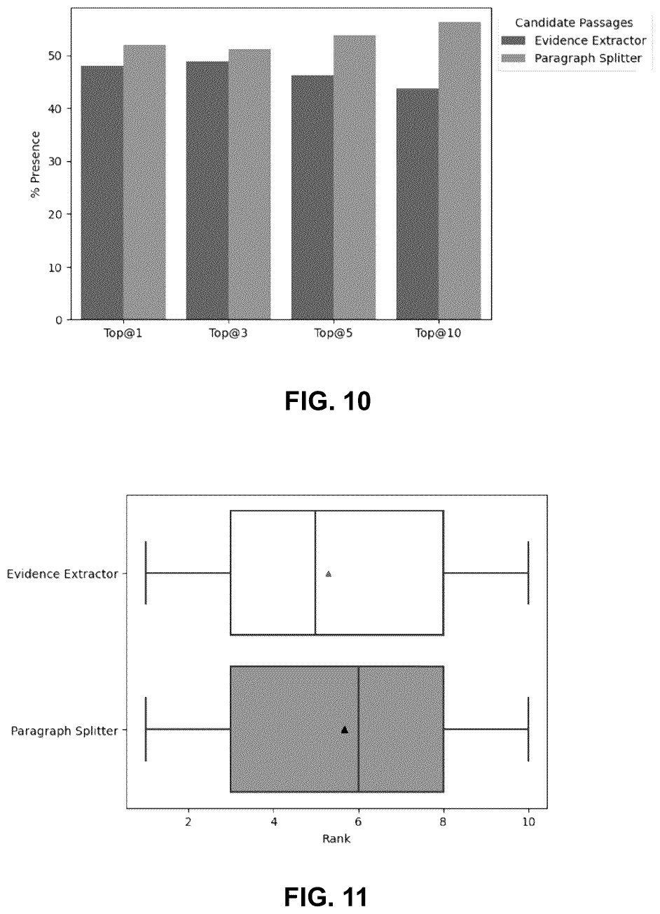

FIGS. 10 and 11 provide a comparison between the evidence extractor 950 and the paragraph splitter 940 of the system 900. These figures illustrate the results of an exploratory study conducted on a sample of 400 queries from the Web Questions dataset (Jonathan Berant, Andrew Chou, Roy Frostig, and Percy Liang. 2013. “Semantic Parsing on Freebase from Question-Answer Pairs. In Proceedings of the 2013 Conference on Empirical Methods in Natural Language Processing”, pages 1533-1544, Seattle, Washington, USA. Association for Computational Linguistics), showing how both methods contribute to the retrieval of relevant passages for ranking.

FIG. 10 illustrates the percentage presence of candidate passages retrieved by both the evidence extractor and the paragraph splitter at various ranking levels. For the top-ranked passage, the evidence extractor ranked highest for 48% of the queries, while the paragraph splitter produced the top passage for 52% of the queries. Similar trends were observed at Top@3, Top@5, and Top@10 levels, where the “@” symbol indicates that the ground truth answer is among the top 3, 5, or 10 scored passages, respectively. This ranking system reflects how well the retrieved passages match the correct answer at different cutoff points.

FIG. 11 presents a box plot showing the distribution of the ranks of the passages selected by the evidence extractor and paragraph splitter. The mean and median ranks for the evidence extractor are marginally better than those for the paragraph splitter, demonstrating that the evidence extractor tends to produce more contextually relevant passages. However, the overall spread and range of ranks suggest that both methods yield useful and relevant results, with the evidence extractor slightly outperforming the paragraph splitter in terms of precision and relevance.

The results shown in FIGS. 10 and 11 highlight the complementary nature of the two methods. The paragraph splitter provides quick processing based on predefined heuristic rules, ensuring efficient extraction of candidate passages. Meanwhile, the evidence extractor applies a more nuanced, semantic analysis to identify self-contained and highly relevant evidence spans, which enhances the accuracy of the retrieval process. By combining both methods, the system can better handle a wide variety of input queries, balancing the need for both efficiency and precision.

This dual approach—using both heuristic-based paragraph splitting and model-based evidence extraction—aims to balance efficiency with precision. The paragraph splitter 940 processes content quickly by following predefined rules, while the evidence extractor 950 applies deeper semantic analysis to extract more targeted and self-contained pieces of information. These two streams of information are then passed to subsequent stages of the system 900, such as a cross-encoder semantic search module 960, where they are ranked and used to generate a more accurate and comprehensive answer to the user's question.

The ranking may be performed by a cross-encoder semantic search module 960 that compares the semantic similarity between the user question and candidate passages. The candidate passages may include one or more of the split paragraphs generated by the paragraph splitter 940 and/or one or more of the extracted evidence spans produced by the evidence extractor 950. In some embodiments, the cross-encoder semantic search module 960 may rank all the split paragraphs and all the extracted evidence spans to ensure comprehensive consideration of all potential passages that might contain relevant information. The cross-encoder semantic search module 960 may be configured to assess how closely each candidate passage semantically aligns with the user question by computing a similarity score based on the contextual meaning of both the user question and the passage.

The ranking may be based on one or more factors, such as relevance to the input question, contextual completeness, and the potential for the passage to provide a self-contained answer. In this context, relevance refers to how closely the content of the passage aligns with the information sought in the user question, while completeness refers to whether the passage contains sufficient information to provide a comprehensive response. Self-containment means that the passage, without the need for additional context, can stand alone as a useful piece of information relevant to answering the user question.

After the ranking process, the cross-encoder semantic search module 960 may select one or more of the top-ranked passages for further processing, based on predetermined criteria such as a similarity score threshold or a maximum number of passages to retrieve. These relevant passages may be then passed along for further analysis, such as citation generation or final answer formulation.

It should be understood that the term “passage” in the context of LLMs refers to a coherent segment of text, which may be a paragraph, an evidence span, or any other logical chunk of text containing relevant information. The passage is typically a self-contained unit that can stand on its own to convey useful information in response to the user query, whether it is derived from a simple paragraph split or a more complex evidence extraction process. In other words, the cross-encoder semantic search module 960 treats both the split paragraphs and the extracted evidence spans as equally valid passages for ranking and comparison, regardless of their origin.

It should also be understood that, while the semantic search in this embodiment is performed by the “cross-encoder” semantic search module 960, other types of semantic search models may also be employed depending on the implementation. A cross-encoder works by jointly encoding the input question and the candidate passage into a single representation, allowing the model to directly compare the semantic similarity between the two. This method may be effective because it evaluates the interaction between the question and the passage simultaneously, which can lead to more accurate relevance rankings. The cross-encoder can process both the question and passage together, ensuring that contextual nuances are fully captured when determining the semantic relationship.

In contrast, another approach may be a bi-encoder model, where the input question and the candidate passage are encoded separately into distinct embeddings. The similarity between the two embeddings is then computed, usually by measuring the cosine similarity between the vector representations. Bi-encoders encode both questions and passages into dense vectors and compare their similarities, often leveraging pre-trained language models to enhance the quality of the vector embeddings. In some cases, systems may also use a hybrid approach, combining elements of bi-encoder and cross-encoder models. For example, the bi-encoder can be used to filter out irrelevant passages quickly, and then the cross-encoder can be applied to the smaller, more relevant subset for more detailed analysis and ranking.

The next step in the flow involves a quote deduplication module 970, which filters out redundant or duplicate quotes (passages) from the ranked results. This ensures that the final set of quotes used for generating the answer is unique and relevant.

Last, the top-ranked and deduplicated quotes (passages) may be passed to an LLM answer composer 980, where the composer formulates a complete response to the user question (the user question is also input to the LM answer composer 980). This response may incorporate citations from the retrieved quotes, thereby grounding the generated answer in external knowledge sources.

The hybrid approach of the Enhanced Adaptive Information Retrieval, as described in the embodiments herein, offers significant advantages by filtering out irrelevant and poor-quality quotes or passages before they are processed by the LLM answer composer 980. By combining heuristic-based paragraph splitting with a trained evidence extraction model as well as the semantic search for ranking, the system ensures that only the relevant and self-contained segments of text are eventually passed to the LLM. This hybrid approach strikes an optimal balance between speed and accuracy, as the heuristic-based splitter allows for rapid processing of large volumes of text, while the evidence extraction model selectively identifies the most contextually appropriate information. As a result, the LLM answer composer 980 is able to work with a refined set of high-quality passages, improving both the performance and the speed of the overall process. The elimination of irrelevant information means the LLM can focus on generating more precise, factually grounded responses without having to process excessive or low-quality content. This not only enhances the user experience by delivering faster, more accurate answers, but also reduces computational overhead, making the system more efficient in resource-constrained environments.

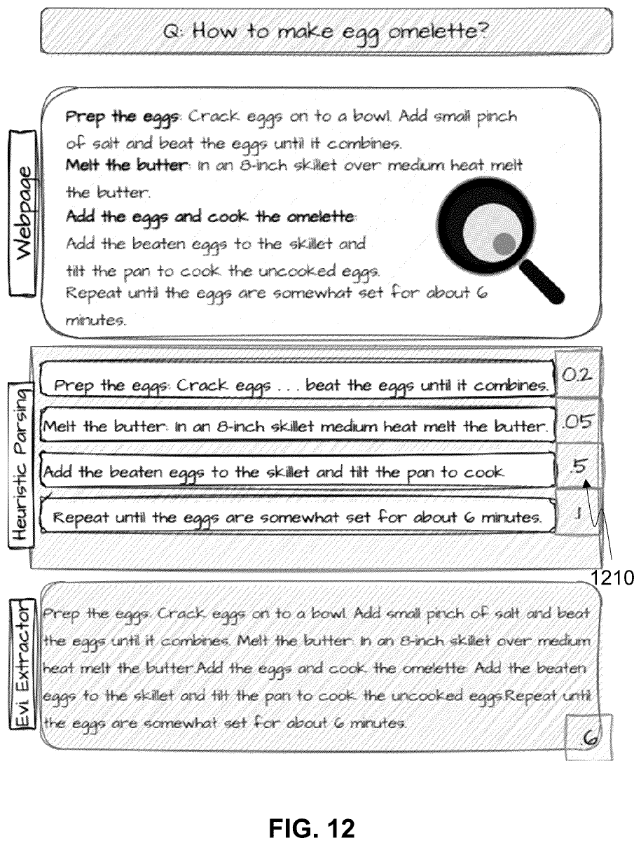

FIG. 12 provides an example illustrating the flow of the multi-stage retrieval process shown in FIG. 9, specifically demonstrating how passages from a webpage are processed, parsed, and assigned relevance scores during the retrieval process. The figure visually depicts the operation of both the heuristic parsing and evidence extraction pathways, as well as the process of ranking the retrieved passages based on relevance.

The process begins with a user question: “How to make egg omelette?” The system first retrieves text content from a webpage, which contains detailed instructions on making an omelette. The original webpage text is shown at the top of the figure, where it is divided into paragraphs providing instructions such as “Prep the eggs”, “Melt the butter”, and “Add the eggs and cook the omelette”.

In the heuristic parsing pathway, the retrieved webpage is divided into smaller segments (or passages) based on predefined rules. For example, the paragraphs are split into manageable pieces, such as “Prep the eggs”, “Melt the butter”, and other relevant instructions. These split passages are each assigned a relevance score, as indicated by the numbers on the right-hand side of each segment, labeled 1210. These scores are calculated based on the semantic similarity between the user's query (user question) and the content of each passage.

Simultaneously, the evidence extraction pathway uses the trained model, such as an encoder-only transformer model, to analyze the same webpage. Unlike the heuristic parser, the evidence extractor processes the entire webpage to identify self-contained evidence spans that are highly relevant to answering the input question. The evidence extractor highlights and extracts the most relevant spans of text, such as the instructions to “Prep the eggs” and “Melt the butter”, without breaking the structure of the text unnecessarily. This ensures that the extracted evidence spans are coherent and directly related to the question.

The relevance scores displayed to the right of each passage (e.g., 0.2, 0.5, 1) represent how relevant each segment is to the user question. A higher score (e.g., “1”) indicates a higher relevance to the user question. These scores are generated by the system's semantic search module, which evaluates the similarity between the input question and each passage. The relevance scores help the system prioritize which passages or evidence spans to use in generating a response, ensuring that the final answer is grounded in the most accurate and contextually relevant information.

It should be understood that the example shown in FIG. 12 is just to help comprehend the working principle of the multi-stage retrieval process and the assignment of relevance scores. The specific format of the relevance scores, such as the numerical values displayed, is only one example of how relevance may be represented. In other implementations, the relevance scores may be represented in other forms, such as percentages, ratings, or categorical labels (e.g., “high”, “medium”, “low”). Additionally, the method of determining these relevance scores may vary depending on the specific model or algorithm employed, and other weighting or ranking systems may be used to evaluate the relevance of the passages. The flexibility in how relevance is calculated and represented allows the system to adapt to different use cases and performance requirements.

Although in above examples, the adaptive information retrieval method is performed by the computer network system 100, in some embodiments, no computer network system 100 is required, and the adaptive information retrieval method may be performed by a computer or computing device 102 or 104.

### Model Training

The evidence extractor component 950, as described in this embodiment, employs a pre-trained model, such as an encoder-only transformer, that is trained to extract evidence spans from text content in response to an input question. The training process for this model enables the evidence extractor to accurately identify relevant, self-contained segments of text that are more likely to support a response to a user's question. This is achieved by training the model on a carefully constructed dataset comprising question-context-evidence triples.

In these embodiments, the training process for the evidence extractor leverages the MS (Microsoft™) Marco dataset, a large-scale collection of approximately 1 million queries sampled from a search engine's (such as Bing™) search logs. This dataset is particularly useful for training models in open-domain question-answering tasks, as it includes a wide range of real-world queries accompanied by relevant web passages. For each query, human editors are presented with 10 candidate passages that may contain the answer. The editors annotate these passages, selecting those they use to compose a well-formed answer. These selected passages are then marked in the metadata with an “is_selected=1” tag, for example, indicating their relevance.

Specifically, the adaptive information retrieval method uses this annotated data to construct a training set. From the Train split of the MS Marco dataset, a subset of 110,000 instances was created using only the passages that the annotators tagged as useful. Each training instance was structured as a three-tuple of (qᵢ, sᵢ, cᵢ), where qᵢ refers to the query, sᵢ refers to the relevant passage span that the annotators used in composing their answer, and cᵢ represents the full text of the webpage or context from which the passage was extracted. This setup ensures that the model is trained on high-quality data, where the relevance of each passage span to the question has been verified by human editors.

The training process involves inputting these question-context-evidence triples into the model. The model processes the training question and the full text of the webpage or other content, learning to identify patterns between the training question and the annotated evidence spans. This process allows the model to develop a deeper understanding of the relationship between a question and the supporting textual evidence found in the context. The goal is for the model to learn how to predict the most relevant evidence spans directly from the text content, even when the evidence may be located in diverse or unexpected parts of the document.

In some embodiments, the training text content may comprise the full text of a webpage relevant to the training question, allowing the model to handle large and unstructured text data typically found on the web. This approach is particularly useful for open-domain question-answering systems, where the text may come from a wide array of sources, such as news articles, blogs, or research papers. The evidence extractor is trained to sift through this unstructured content and extract precise, self-contained evidence spans that directly answer the question.

In certain implementations, the training text content may also include passages that have been assigned predefined relevance scores by human editors. These scores indicate the likelihood of a passage containing an answer to the training question, providing additional guidance to the model during the training process. The relevance scores allow the model to prioritize certain passages over others, helping it to focus on the most promising parts of the text when extracting evidence spans.

The model may be trained using a loss function that compares the predicted evidence spans with the annotated evidence spans in the training dataset. This comparison allows the model to iteratively improve its accuracy in identifying relevant spans. The result is a model that can efficiently and effectively extract evidence spans from text content, providing strong support for answering user queries in real-world applications. The adaptive nature of this training process ensures that the evidence extractor is capable of handling a wide variety of input queries, improving the overall performance of the system 900 in open-domain question-answering tasks.

### Test Results

To demonstrate the effectiveness and performance of the adaptive information retrieval (AIR) method according to the embodiments described herein, several tests were conducted. These tests evaluated the AIR method in comparison with existing retrieval systems, such as WebGLM, using standard datasets. The results were assessed based on various metrics to showcase the advantages of AIR in extracting relevant and self-contained information, as well as its ability to handle a wide variety of queries across different datasets.

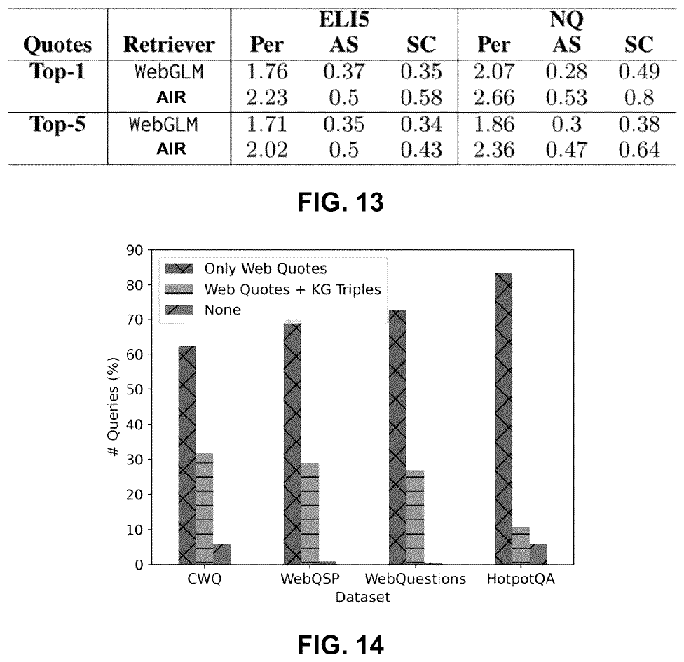

FIG. 13 presents a comparison between WebGLM and the AIR method in terms of human evaluation on two datasets: Explain Like I'm 5 (ELI5) and Natural Questions (NQ). The evaluation metrics used include Pertinence (Per), Answer Span (AS), and Self-Containment (SC). Human annotators rated the relevance, answer coverage, and self-contained nature of the retrieved web quotes. The AIR method demonstrated significant improvement over WebGLM across all three metrics, both for top-ranked quotes (Top-1) and the top five retrieved quotes (Top-5). These results indicate that the AIR method is more effective at retrieving relevant, comprehensive, and self-contained passages that better answer the user's queries.

FIG. 14 shows the distribution of quotes retrieved by the answer composer from different data sources across queries from two Knowledge Graph Question Answering (KGQA) datasets and two Open-Domain Question Answering (ODQA) datasets. The chart illustrates the proportion of queries answered using only web quotes, web quotes combined with Knowledge Graph (KG) triples, and queries without any retrieved quotes. It highlights the effectiveness of the AIR method in sourcing relevant information from both web and KG sources, demonstrating the method's versatility in handling diverse datasets.

Table 2 presents a comparative analysis of the performance of WebGLM and the adaptive information retrieval method disclosed herein across several datasets. The Hits@1 accuracy metric, which measures the percentage of correctly answered queries, is used for evaluation. Hits@1 represents the proportion of times that the correct (or relevant) answer, document, or item is ranked first (i.e., at position 1) in the retrieved list. The analysis covers Knowledge Graph Question Answering (KGQA) datasets such as WebQSP, CWQ, GrailQA, and SimpleQA, as well as for Open-Domain Question Answering (ODQA) datasets like WebQuestions, Hotpot, and Natural Questions (NQ). The adaptive information retrieval method demonstrates significant improvements in overall performance, achieving a higher average Hits@1 accuracy compared to WebGLM, reflecting its ability to correctly rank relevant answers at the top of the list.

TABLE 2
Performance comparison between WebGLM and AIR across different datasets

| | WebQSP | CWQ | WebQ | Hotpot | GrailQA | SimpleQA | NQ | Average |
|---|---|---|---|---|---|---|---|---|
| WebGLM | 63.5 | 42.3 | 54.3 | 38.7 | 34.3 | 29.7 | 57.6 | 45.8 |
| AIR | 68 | 48.1 | 58.1 | 42.9 | 36.7 | 33 | 64.7 | 50.2 |

As illustrated in Table 2, the adaptive information retrieval method achieved notable improvements across several datasets. Specifically, for ODQA datasets, the method significantly outperforms WebGLM, showcasing its strength in handling multi-hop, open-domain questions. Additionally, the method performs surprisingly well on KGQA datasets, despite relying solely on web quotes. These results highlight the flexibility and effectiveness of the AIR method in addressing diverse types of queries across different knowledge domains.

The improved performance across various datasets underscores the AIR method's capability to extract relevant, self-contained quotes from web sources, providing robust answers for both single-hop and multi-hop queries.

Table 3 provides a comparison of several models, including the adaptive information retrieval method described herein (denoted as “EWEK-QA”), based on their ability to answer 92 challenging queries across various domains. These queries are hand-picked from datasets such as SimpleQA and CWQ and cover a range of query types, including 20 factual queries (from SimpleQA and CWQ), 17 verbose factual queries, 15 recent factual queries requiring knowledge from approximately one year ago, 20 yes/no reasoning queries, and 20 factual reasoning queries (from CWQ).

TABLE 3
Overall performance between models in terms of correctness

| Model | IDK | Incorrect | Correct |
|---|---|---|---|
| IO Prompt w/ChatGPT | 0.38 | 0.21 | 0.41 |
| CoT w/ChatGPT | 0.41 | 0.18 | 0.40 |
| ToG | 0.25 | 0.25 | 0.50 |
| WebGLM | 0.00 | 0.47 | 0.53 |
| EWEK-QA w/KG | 0.00 | 0.48 | 0.52 |
| EWEK-QA w/Web | 0.01 | 0.41 | 0.58 |
| EWEK-QA w/KG + Web | 0.00 | 0.26 | 0.74 |

The table shows three annotation labels for human evaluation: IDK (I Don't Know, indicating an inability to answer), Incorrect, and Correct. As shown, the adaptive information retrieval method using both Knowledge Graph (KG) and web-based sources (EWEK-QA w/KG+Web) demonstrated the best overall performance, with a correctness score of 0.74, significantly outperforming the baseline WebGLM model by 21%.

Additionally, models such as Text over Generative (ToG) and WebGLM show competitive performance in terms of correct answers, but ToG has a higher proportion of “IDK” responses due to reliance on ChatGPT's parametric knowledge. The combination of KG and web sources (EWEK-QA w/KG+Web) proves most effective in reducing incorrect and IDK answers, showcasing the strength of combining multiple knowledge sources to improve correctness and accuracy.

Table 4 presents an efficiency and performance analysis comparing different models on the WebQSP and WebQuestions datasets. The models include ToG, WebGLM, and EWEK-QA (denoted as “Ours”). The analysis focuses on the average runtime (in seconds), the average number of LLM calls, and Hits@1 accuracy across the datasets.

TABLE 4
Efficiency and performance analysis comparing models

| | | | Avg. | Avg. # | |
|---|---|---|---|---|---|
| Dataset | Method | LLM | Runtime (s) | LLM calls | Hits@1 |
| WebQSP | ToG | Llama-13B | 128.7 | 5.6 | 45.6 |
| | WebGLM | WebGLM-10B | 44 | 1 | 65 |
| | EWEK-QA (Ours) | Llama-13B | 29 | 1 | 73.2 |
| | | WebGLM-10B | 40 | 1 | 72.9 |
| | | WebGLM-2B | 21 | 1 | 68.9 |
| WebQuestions | ToG | Llama-13B | 124.4 | 5.7 | 37.8 |
| | WebGLM | WebGLM-10B | 45 | 1 | 54.3 |
| | EWEK-QA (Ours) | Llama-13B | 26 | 1 | 60.8 |
| | | WebGLM-10B | 35 | 1 | 61.2 |
| | | WebGLM-2B | 20 | 1 | 58.4 |

For the WebQSP dataset, ToG with LLaMA-13B has an average runtime of 128.7 seconds and requires 5.6 LLM calls, achieving a Hits@1 score of 45.6%. By contrast, WebGLM using WebGLM-10B significantly reduces the runtime to 44 seconds with only one LLM call, and it achieves a higher Hits@1 score of 65%. The EWEK-QA method, leveraging LLaMA-13B, WebGLM-10B, and WebGLM-2B, demonstrates even better performance, achieving a Hits@1 score of as high as 73.2% with a runtime of only 29 seconds for LLaMA-13B and 21 seconds for WebGLM-2B.

Similarly, for the WebQuestions dataset, ToG with LLaMA-13B has an average runtime of 124.4 seconds and 5.7 LLM calls, with a Hits@1 score of 37.8%. WebGLM with WebGLM-10B improves the Hits@1 score to 54.3%, while EWEK-QA delivers improved performance with a Hits@1 score of 61.2% using WebGLM-10B and 58.4% using WebGLM-2B.

The table illustrates the trade-offs between model size, runtime, and the number of LLM calls. Larger models like LLaMA-13B may require more time and multiple LLM calls, increasing resource consumption. EWEK-QA, however, strikes a balance by utilizing smaller models, such as WebGLM-10B and WebGLM-2B, with significantly reduced runtimes and fewer LLM calls, while maintaining competitive performance. The results demonstrate that the EWEK-QA method achieves high performance with lower computational costs and greater efficiency compared to other models such as ToG.

In summary, EWEK-QA outperforms the other models in terms of efficiency, requiring fewer LLM calls and less runtime while delivering competitive or superior Hits@1 performance, making it a viable solution for resource-constrained applications.

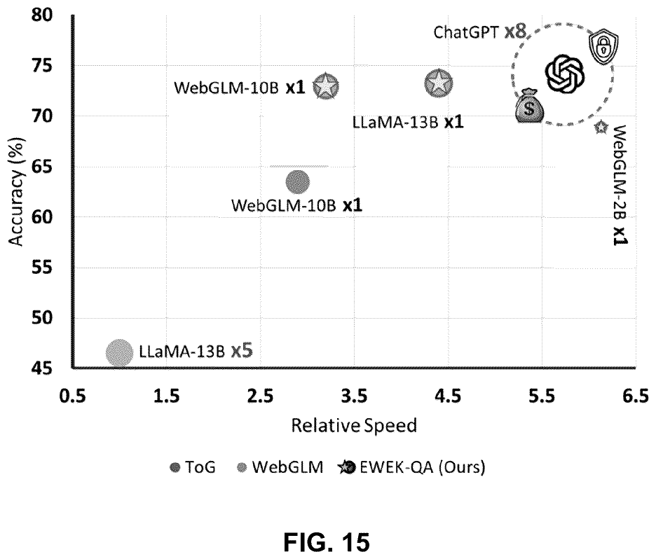

FIG. 15 provides a visual comparison where each circle represents a solution, indicating the model's name and the number of calls to the LLM (denoted by xn). The circle size reflects the relative size of the backbone LLM used. Relative speed, plotted on the x-axis, is compared to ToG with LLaMA-13B as a reference point, and accuracy is shown on the y-axis. For example, ToG with ChatGPT calls the ChatGPT system 8 times, which may lead to higher costs and potential privacy concerns for sensitive applications. In contrast, EWEK-QA based on LLaMA-13B achieves comparable performance to ChatGPT while using fewer LLM calls and avoiding closed-source LLM dependencies.

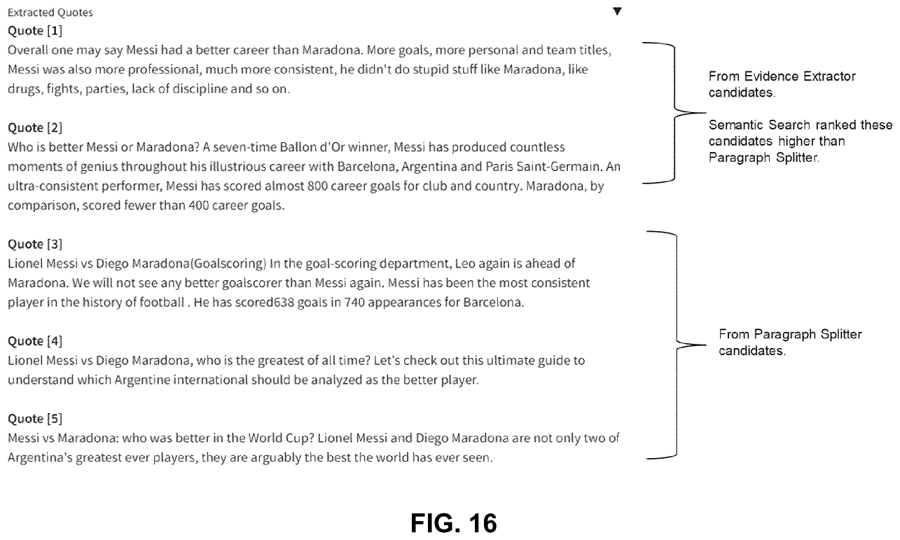

FIG. 16 shows the extracted quotes when the adaptive information retrieval method disclosed herein is applied to answer the question: “Messi or Maradona, who is better?” The extracted quotes illustrate that the evidence retrieved from the evidence extractor component is ranked higher in relevance than those retrieved by the paragraph splitter.

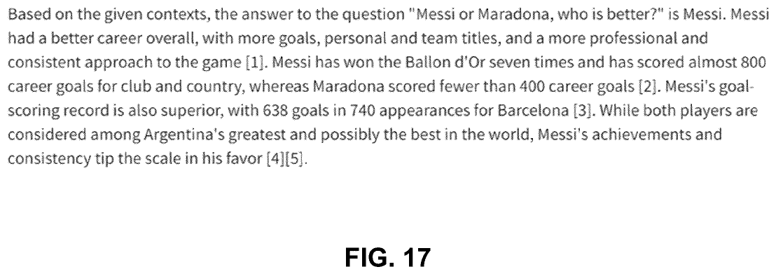

FIG. 17 presents the LLM-generated answer using the retrieved evidence from the semantic search process. The final answer is more comprehensive and grounded in the high-quality evidence passages, demonstrating an improvement in the overall quality of the output.

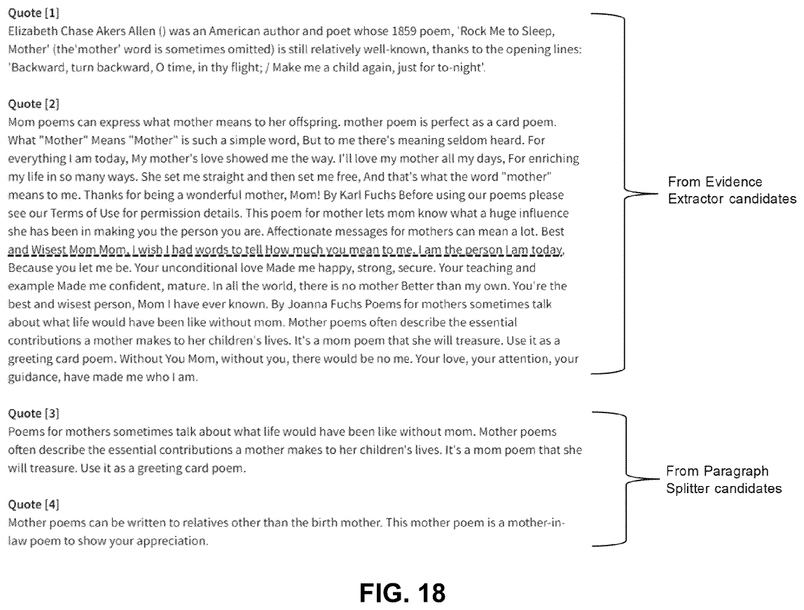

FIG. 18 shows the extracted quotes when the adaptive information retrieval method is used to answer the question: “Write a piece of poem about mother.” The extracted quotes indicate the evidence passages retrieved from both the evidence extractor and the paragraph splitter.

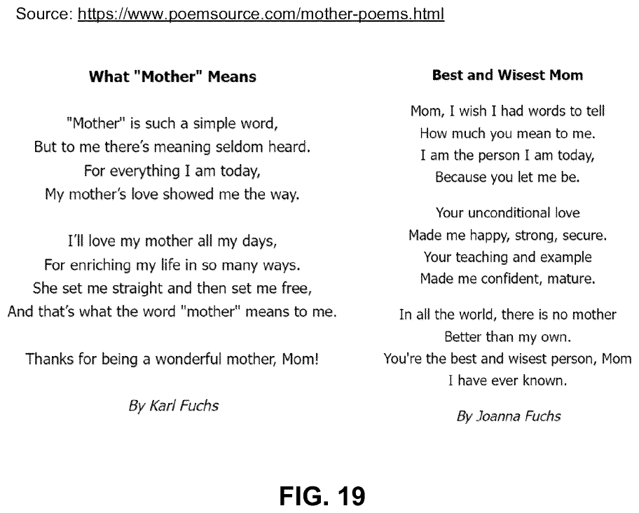

FIG. 19 presents two exemplary poems about a mother (sourced from https://www.poemsource.com/mother-poems.html), demonstrating the relevance of the extracted evidence passages. Passage [2], extracted during semantic search, is the only one that contains the full poem from the source, highlighting that passages retrieved from the evidence extractor are more likely to be self-contained and useful for generating a complete and accurate answer.

The adaptive information retrieval method disclosed herein offers several technical benefits and advantages. By utilizing semantic search to retrieve relevant evidence passages for a given question, the method enhances the quality of information retrieval. Unlike traditional approaches that rely solely on heuristics such as fixed-length segments or paragraphs divided by line breaks, the present disclosure augments the process by incorporating “evidence spans” extracted by a trained deep learning model. This augmentation enhances the precision and relevance of the retrieved passages.

One advantage is the reduction of noise in the output. Heuristic-based methods, such as paragraph splitting, often retrieve entire paragraphs, even if only a small portion is relevant to the question. In contrast, the intelligent evidence extractor in this system assists in reducing irrelevant information, resulting in less noisy, higher-quality candidate passages. Additionally, the extracted evidence spans may be more likely to be self-contained, as they are selected based on semantic relevance rather than arbitrary text divisions. This approach also improves the coverage of queries, allowing the system to handle a wide variety of open-domain questions from diverse external knowledge sources, making it particularly suitable for use in generative search engines.

Furthermore, the adaptive information retrieval method provides a robust solution by offering a hybrid approach that merges heuristic-based passage extraction with a trained encoder-only transformer model for evidence extraction. This combination can provide a more efficient retrieval process while maintaining high-quality output. The system also offers the ability to create and utilize training data specifically for adaptive quote extraction, enhancing its performance in some applications.

In practical applications, this method can be implemented in various fields such as search engines, document retrieval systems, chatbots, and voice assistants. By improving the relevance and self-containment of retrieved information, it enables more accurate and contextually appropriate responses. The present disclosure can enhance the functioning of computer systems by reducing the computational resources used in irrelevant data processing and by potentially improving the quality and speed of information retrieval. In doing so, it allows systems to better serve user queries in real-time, making it highly beneficial for any application requiring fast, reliable access to diverse knowledge sources.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A computerized method for retrieving relevant information in response to an input question, the method comprising:
obtaining text content in relation to the input question;
partitioning the obtained text content into one or more paragraphs based on a predefined rule;
extracting one or more evidence spans from the obtained text content relevant to the input question using a trained language model; and
performing semantic search on the one or more paragraphs and the extracted one or more evidence spans based on the input question to rank candidate passages, wherein each of the candidate passages comprises one of the one or more paragraphs or one of the one or more extracted evidence spans that is relevant to the input question.

2. The method of claim 1, wherein obtaining the text content comprises conducting a search based on the input question using an Internet-based or Intranet-based search engine.

3. The method of claim 1, wherein the predefined rule is a heuristic rule, and wherein the partitioning comprises:
utilizing a structural element in the text content to define boundaries of the one or more paragraphs;
in response to one of the one or more paragraphs containing fewer than a predefined minimum number of tokens, discarding the paragraph; and
in response to one of the one or more paragraphs containing more than a predefined maximum number of tokens, dividing the paragraph into shorter paragraphs without breaking sentence structures.

4. The method of claim 3, wherein the structural element comprises one or more of: a newline character, a paragraph tag, a sentence boundary, a section header, or a list item.

5. The method of claim 1, wherein performing the semantic search comprises inputting the one or more paragraphs, the extracted one or more evidence spans, and the input question to a retriever configured to rank the candidate passages based on semantic similarity between each of the candidate passages and the input question.

6. The method of claim 1, further comprising fine-tuning the trained language model using a training dataset comprising a plurality of question-context-evidence triples, each of the plurality of question-context-evidence triples containing:
a training question;
context text comprising training text content relevant to the training question; and
one or more training evidence spans corresponding to one or more portions of the training text content, wherein the one or more training evidence spans are annotated by a human editor based on their relevance to the training question.

7. The method of claim 1, wherein the candidate passages are ranked based on one or more criteria selected from the group consisting of relevance in relation to the input question, coverage, and self-containment, wherein the self-containment represents one of the candidate passages containing complete information to answer the input question.

8. The method of claim 1, further comprising caching the obtained text content associated with the input question for subsequent queries related to the input question.

9. The method of claim 1, wherein the trained language model is an encoder-only transformer model.

10. A method for training a language model, wherein the language model extracts one or more evidence spans from text content and an input question, the method comprising:
providing a training dataset comprising a plurality of question-context-evidence triples, each of the plurality of question-context-evidence triples containing:
a training question;
training text content relevant to the training question; and
one or more training evidence spans corresponding to one or more portions of the training text content, wherein the one or more training evidence spans have been annotated by a human editor based on their relevance to the training question;
inputting the training dataset to the language model; and
training the language model to learn patterns between the training questions and the annotated training evidence spans within the training text content.

11. The method of claim 10, wherein the training text content comprises a full text of a webpage relevant to the training question.

12. The method of claim 10, wherein the language model is an encoder-only transformer model.

13. A system for retrieving relevant information in response to an input question, the system comprising:
a processor; and
a memory communicatively coupled to the processor and storing instructions that, when executed by the processor, cause the system to:
obtain text content in relation to the input question;
partition the obtained text content into one or more paragraphs based on a predefined rule;
extract one or more evidence spans from the obtained text content relevant to the input question using a trained language model; and
perform semantic search on the one or more paragraphs and the extracted one or more evidence spans based on the input question to rank candidate passages, wherein each of the candidate passages comprises one of the one or more paragraphs or one of the one or more extracted evidence spans that is relevant to the input question.

14. The system of claim 13, wherein the memory stores the instructions that, when executed by the processor, cause the system to conduct a search based on the input question using an Internet-based or Intranet-based search engine to obtain the text content.

15. The system of claim 13, wherein the memory stores the instructions that, when executed by the processor, cause the system to partition the text content according to a heuristic rule, wherein the partitioning comprises:
utilizing a structural element in the text content to define boundaries of the one or more paragraphs;
in response to one of the one or more paragraphs containing fewer than a predefined minimum number of tokens, discarding the paragraph; and
in response to one of the one or more paragraphs containing more than a predefined maximum number of tokens, dividing the paragraph into shorter paragraphs without breaking sentence structures.

16. The system of claim 13, wherein the memory stores the instructions that, when executed by the processor, cause the system to perform semantic search by inputting the one or more paragraphs, the extracted one or more evidence spans, and the input question into a retriever configured to rank the candidate passages based on semantic similarity between each of the candidate passages and the input question.

17. The system of claim 13, wherein the memory stores the instructions that, when executed by the processor, cause the system to rank the candidate passages based on one or more criteria selected from the group consisting of relevance in relation to the input question, coverage, and self-containment, wherein the self-containment represents one of the candidate passages containing complete information to answer the input question.

18. The system of claim 13, wherein the memory stores the instructions that, when executed by the processor, cause the system to cache the obtained text content associated with the input question for subsequent queries related to the input question.

19. The system of claim 13, wherein the trained language model is an encoder-only transformer model.
